(19) United States
(12) Patent Application Publication
(10) Pub. No.: US 2023/0152453 A1
(43) Pub. Date: May 18, 2023

(54) OPTICAL PHASED ARRAY DEVICE FOR LIDAR SENSOR

(71) Applicants: WAY OPTICS CO., LTD., Daejeon (KR); KOREA ADVANCED INSTITUTE OF SCIENCE AND TECHNOLOGY, Daejeon (KR)

(72) Inventors: Yong Tae LEE, Daejeon (KR); Mid Eum BAEK, Daejeon (KR); Chang Su LEE, Daejeon (KR); Hyo-Hoon PARK, Daejeon (KR); Hyeonho YOON, Daejeon (KR); Jae-Yong KIM, Daejeon (KR)

(21) Appl. No.: 18/155,064

(22) Filed: Jan. 17, 2023

Related U.S. Application Data
(63) Continuation of application No. PCT/KR2022/009966, filed on Jul. 8, 2022.

(30) Foreign Application Priority Data
Aug. 23, 2021 (KR) 10-2021-0110921

(51) Int. Cl. G01S 17/26; G02F 1/29; G01S 7/481; G02B 6/125

(52) U.S. Cl. CPC G01S 17/26; G02F 1/292; G01S 7/4816; G02B 6/125

(57) ABSTRACT

An optical phased array device for a LIDAR sensor includes: a light source configured to irradiate a laser beam having a predetermined wavelength band; an input waveguide through which the laser beam irradiated from the light source passes; a slab waveguide disposed at an output end of the input waveguide to branch an optical signal input from the input waveguide; and a channel waveguide configured to distribute and guide the optical signal, branched by the slab waveguide, to M channels and to radiate the optical signal onto a free space. The channel waveguide may include a silia optical waveguide disposed for each of the M channels, and a length of each of the optical waveguides has a length difference ΔL from an adjacent waveguide.

### CROSS-REFERENCE TO RELATED APPLICATIONS

This application is a continuation of and claims priority to PCT/KR2022/009966 filed on Jul. 8, 2022, which claims priority to Korea Patent Application No. 10-2021-0110921 filed on Aug. 23, 2021, the entireties of which are both hereby incorporated by reference

### TECHNICAL FIELD

The present disclosure relates to an optical phased array device with silica optical waveguides for a LIDAR sensor.

### BACKGROUND

The description in this section merely provides background information of embodiments of the present disclosure and is not intended to specify related arts of the present disclosure.

An optical phased array (OPA) technology using a semiconductor integration technology may be utilized for light detection and ranging (LIDAR) sensor technology providing a three-dimensional (3D) image including distance information. The optical phased array device may be implemented to be miniaturized at low costs, as compared with a mechanically rotating laser beam scanner according to the related art.

LIDAR is technology for detecting a distance to an object by measuring a time-of-flight (ToF) that is a time for which a laser pulse transmitted from a transmitter is reflected on the object and then returns to a detector. Due to the advent of the Fourth Industrial Revolution and the commercialization of autonomous driving technology, LIDAR technology has attracted more attention in recent years. In particular, small LIDAR may be installed in a small weapon system such as a drone, an unmanned robot, or an unmanned aerial vehicle, so that research into LIDAR has been actively conducted in the field of defense.

In the early stage, a silicon-based optical phased array structure was proposed. However, the optical phased array structure was limited in obtaining a high output due to non-linearity occurring when high power is applied to an optical waveguide. Therefore, the optical phased array structure has difficulty in detecting an object at a relatively long distance, so that it may be difficult to apply the optical phase array structure to a field such as LIDAR. To address such an issue, an optical phased array structure based on a silicon nitride, having a relatively low refractive index as compared with silicon, was proposed. Through years of research, it was found that an optical phased array structure based on a silicon nitride is applicable to actual systems such as LIDAR and short-range communications.

An optical phased array antenna is advantageous in steering a laser beam vertically and horizontally without a mechanical driving unit. The optical phased array antenna may steer a beam by adjusting a spacing of an antenna grating structure or changing a wavelength of a wave passing through the antenna. In addition, the optical phased array antenna may steer a beam by adjusting a phase of a laser pulse passing through each channel of the antenna using a thermo-optic phase modulator or an electro-optic phase modulator.

FIG. 1 is a diagram illustrating a configuration of an optical phased array antenna according to an example embodiment of the related art, and FIG. 2 is a diagram illustrating an integrated circuit of the optical phased array antenna according to an example embodiment of the related art.

Referring to FIG. 1, an optical phased array antenna 10 includes an optical waveguide 11 through which a laser pulse passes, an optical splitter 12 distributing the laser pulse to N channels, an optical phase modulator 13 adjusting a phase of the laser pulse passing through each channel 14, and a grating coupler (or an optical antenna array) 15 having a diffraction grating structure radiating the laser pulse.

A laser irradiated to the optical waveguide 11 is radiated onto a free space via the optical splitter 12, the optical phase modulator 13, and the grating coupler 15. In this case, the optical phased array antenna 10 may steer the radiated laser beam in a vertical direction (a Y-direction) direction by changing a wavelength of a laser pulse, and may steer the radiated laser beam in a horizontal (an X-direction) direction by changing a difference in phases between adjacent channels.

As illustrated in FIG. 2, the optical phased array antenna 10 may be integrated into a semiconductor substrate together with a light source and a detector by silicon photonics technology. The optical phase modulator 13 may be implemented in a traveling wave electrode structure having phase inverting characteristics, and the electrode structure may be designed to be flexible with respect to a target pass bandwidth and a central frequency. Such a traveling wave electrode has a structure in which a distribution of an electric field applied from an electrode to the optical waveguide 11 is uniform in an entire modulation region, whereas a phase inverting traveling wave electrode has a structure in which a vector of an electric field distribution is alternately changed by dividing a modulation region into M sections.

The above-described optical phased array antenna 10 may be integrated by silicon photonics technology and manufactured to have a small size, and may have a small radius of curvature. However, the optical phased array antenna 10 may have large insertion loss in an OPA and have difficulty in matching a phase, and may necessarily require an active control element such as an optical phase modulator.

Silica optical waveguide process technology, requiring expensive equipment and process technology, has advantages in which no active control element is required, insertion loss is low, and crosstalk characteristics are excellent, as compared with an OPA using silicon photonics technology. However, the silica optical waveguide process technology has disadvantages such as a large chip size, difficulty in integration on a silica substrate, and a large radius of curvature. In particular, the silica optical waveguide process technology may have a high degree of technical difficulty and may require high costs for research and development, in detail, high costs and a large amount of time for research, development, and manufacturing performed by individual companies because there are sufficient know-how of researchers and equipment in each specialized process.

### SUMMARY

An aspect of the present disclosure is to provide an optical phased array device for a LIDAR sensor, manufactured using a silica optical waveguide having low insertion loss and improved diffraction characteristics.

However, the technical problem to be solved by the present embodiment is not limited to the above-mentioned technical problem, and another technical problems may be present.

An optical phased array device for a LIDAR sensor according to an example embodiment includes: a light source configured to irradiate a laser beam having a predetermined wavelength band; an input waveguide through which the laser beam irradiated from the light source passes; a slab waveguide disposed at an output end of the input waveguide to branch an optical signal input from the input waveguide; and a channel waveguide configured to distribute and guide the optical signal, branched by the slab waveguide, to M channels and to radiate the optical signal onto a free space. The channel waveguide may include a silica optical waveguide disposed for each of the M channels, and a length of each of the optical waveguides has a length difference ΔL from an adjacent waveguide.

In an example embodiment, when a diffraction order m (where m is an integer) is determined based on a central wavelength λ₀ of light incident from a center of an input end of the channel waveguide and traveling to a center of an output end of the channel waveguide, the length difference ΔL may be determined depending on the central wavelength λ₀ and the diffraction order m.

In an example embodiment, a traveling direction of incident light may be changed by a length difference of each optical waveguide of the channel waveguide when a wavelength of the incident light is changed.

In an example embodiment, each of the waveguides arranged in the channel waveguide may include: a first waveguide region formed to have a straight line shape having a predetermined length to move an optical signal input from the input waveguide; a second waveguide region connected to the first waveguide region and formed to have a curved shape having a predetermined curvature; and a third waveguide region formed to have a straight line shape having a predetermined length such that an optical signal passing through the second waveguide region travels in a predetermined direction by optical diffraction, and the first waveguide region, the second waveguide region, and the third waveguide region allow each waveguide to have a length difference ΔL from an adjacent waveguide.

In an example embodiment, an inclined surface having a predetermined slope may be formed at an output end of the channel waveguide.

In an example embodiment, a waveguide disposed in the channel waveguide may include a core and a cladding. The lens may be disposed on a surface of the cladding, and an optical axis of the core and an optical axis of the lens may intersect each other at a single point.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a diagram illustrating a configuration of an optical phased array antenna according to an example embodiment of the related art.

FIG. 2 is a diagram illustrating an integrated circuit of the optical phased array antenna according to an example embodiment of the related art.

FIG. 3 is a block diagram illustrating a configuration of an optical phased array device for a LIDAR sensor according to an aspect of the present disclosure.

FIG. 4 is a diagram illustrating an arrangement state of an optical splitter and a channel waveguide depending on a pre-designed diffraction order and a central wavelength in an optical phased array device for a LIDAR sensor according to an aspect of the present disclosure.

FIG. 5 is a diagram illustrating an output end of the channel waveguide of FIG. 4.

FIG. 6 is a diagram illustrating a light intensity distribution at an input waveguide and a light intensity distribution at an output end of a channel waveguide of an optical phased array device for a LIDAR sensor according to an aspect of the present disclosure.

FIG. 7 is a block diagram illustrating a configuration of an optical phased array device for a LIDAR sensor according to an example embodiment of the present disclosure.

FIG. 8 is a cross-sectional view illustrating an output end of a channel waveguide according to an example embodiment of the present disclosure.

FIG. 9 is a diagram illustrating a light intensity distribution at an output end of a channel waveguide of an optical phased array device for a LIDAR sensor according to an example embodiment of the present disclosure.

FIG. 10 is a diagram illustrating a waveguide arrangement depending on a pre-designed diffraction order and a central wavelength according to an example embodiment of the present disclosure.

FIG. 11 is a diagram illustrating a difference in lengths for each waveguide region of FIG. 10.

FIG. 12 is a diagram illustrating a total length of a reference optical waveguide according to an example embodiment of the present disclosure.

FIG. 13 is a cross-sectional view illustrating a configuration of a channel waveguide according to an example embodiment of the present disclosure.

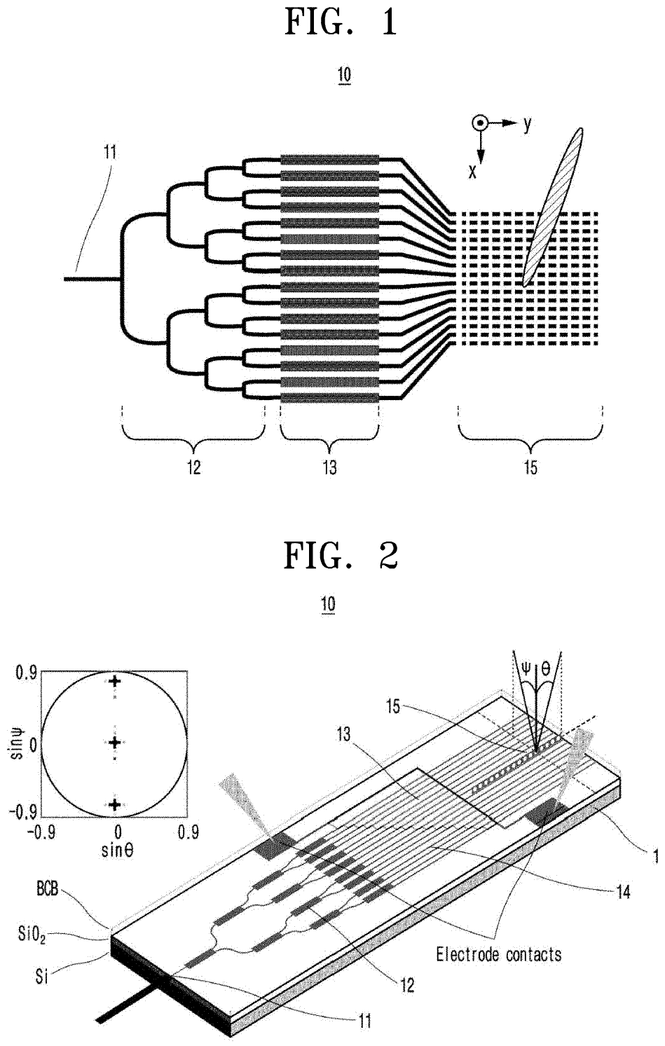

### DETAILED DESCRIPTION

Various modifications may be made to the present disclosure, which can have several embodiments, and specific embodiments will be illustrated in the drawings and described in detail.

However, this is not intended to limit the present disclosure to the specific embodiments, and it should be understood that all modifications, equivalents, or substitutions included in the spirit and scope of the present disclosure are included.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred embodiments of the present disclosure will be described in greater detail with reference to the drawings. Like numbers refer to like elements throughout the description of the figures to facilitate general understanding in explaining the present disclosure, and a repeated description of the elements will be omitted.

An optical phased array device according to the related art should use an active control element such as an optical phase modulator, and may be integrated using silicon photonics but have a disadvantage of high insertion loss in an OPA. To address such an issue, the present disclosure intends to manufacture an optical phased array device using a silica optical waveguide having low insertion loss and improved diffraction characteristics of an OPA while sufficiently utilizing silicon photonics technology.

FIG. 3 is a block diagram illustrating a configuration of an optical phased array device for a LIDAR sensor according to an aspect of the present disclosure.

Referring to FIG. 3, an optical phased array device 100 for a LIDAR sensor may include a light source 110, an input waveguide 120, an optical splitter 130, and a channel waveguide 140.

The light source 110 may irradiate a laser beam of a predetermined wavelength band, and may be implemented as a wavelength-tunable laser diode which may change an oscillation wavelength within a predetermined range.

The input waveguide 120 may allow the laser beam, irradiated from the light source 110, to pass therethrough. The optical splitter 130 may split an optical signal, input from the input waveguide 120, into M channels to have uniform power. The optical splitter 130 may include at least one optical coupler having N input ports and M output ports (M>N), and the optical couplers may uniformly distribute and transfer the optical power of the input laser beam to other channels.

The channel waveguide 140 may split and transmit the optical signal, distributed from the optical splitter 130, to the output ends 141 having regular intervals through M channels. The output end 141 of the channel waveguide 140 may radiate the waveguided optical signal onto a free space. In this case, M silica optical waveguides WG₁ to WG_{M} may be arranged in the channel waveguide 141, and each of the optical waveguides WG₁ to WG_{M} may have a length difference ΔL from an adjacent optical waveguide.

$${n}_{c} Δ L = m {λ}_{0} \qquad [ Equation 1 ]$$

In Equation 1, n_{c} is a refractive index of an optical waveguide, m is a diffraction order, and λ₀ is a central wavelength for a wavelength λ of incident light. When light having a central wavelength λ₀ is incident on a central input terminal and then proceeds to a central output end and a diffraction order m (where m is an integer) is determined at the output end of the channel waveguide 140 with respect to the central wavelength λ₀, ΔL of each optical waveguide of the channel waveguide 140 may be determined based on Equation 1. In this case, the higher the diffraction order M is, the more straightness of the light may be improved.

The light, split from the light source 110 to M branches, may straightly travel in a specific direction. Such a phenomenon may be caused by light diffraction at the output end 141 of the channel waveguide 140 in which bent optical waveguides having a constant length difference ΔL are arranged. In this case, when a wavelength of the incident light is changed, a traveling direction of the light may be automatically changed by the length difference (an optical path difference) ΔL, allowing the optical phased array device 100 to steer the beam for a LIDAR sensor.

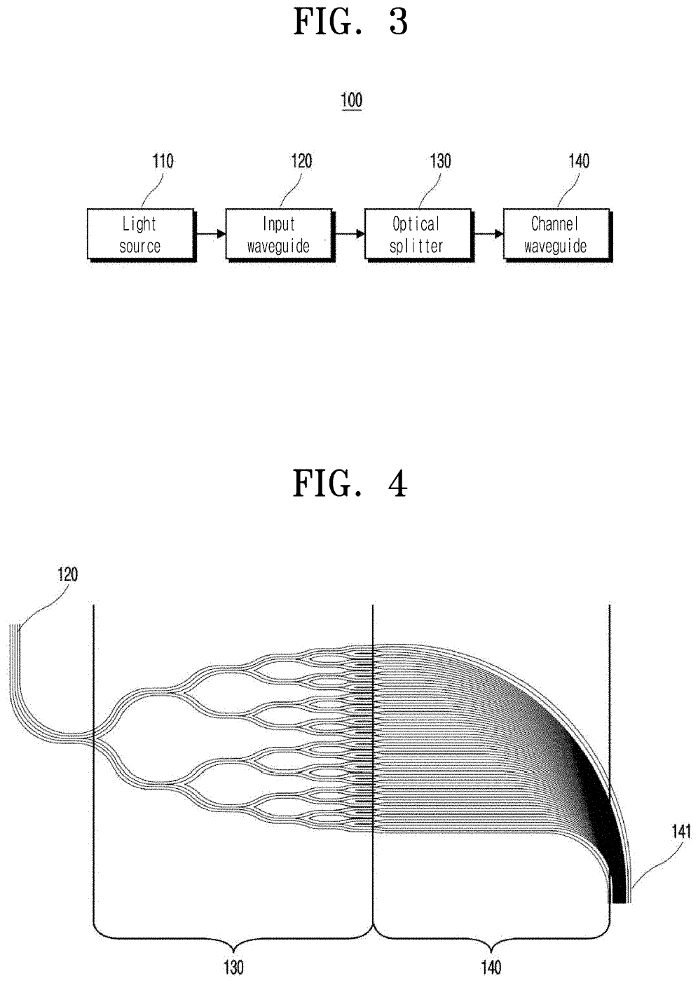

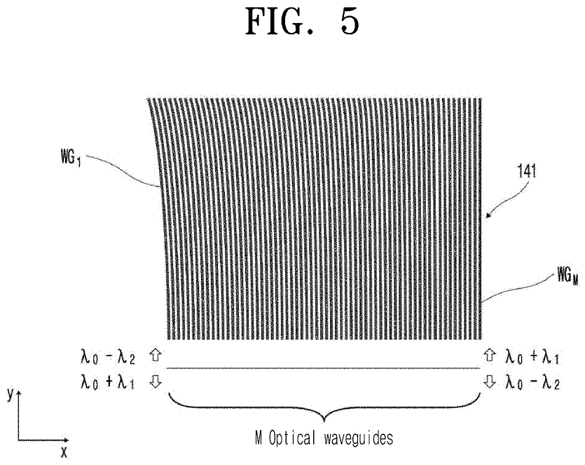

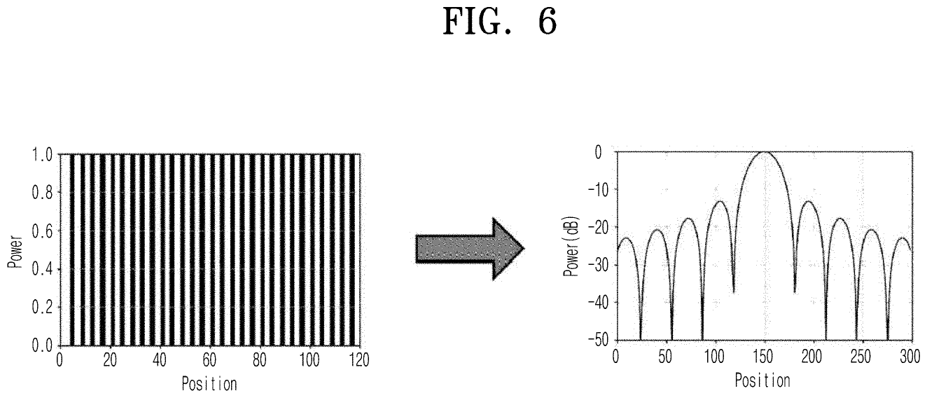

FIG. 4 is a diagram illustrating an arrangement state of an optical splitter and a channel waveguide depending on a pre-designed diffraction order and a central wavelength in an optical phased array device for a LIDAR sensor according to an aspect of the present disclosure, FIG. 5 is a diagram illustrating an output end of the channel waveguide of FIG. 4, and FIG. 6 is a diagram illustrating a light intensity distribution at an input waveguide and a light intensity distribution at an output end of a channel waveguide of an optical phased array device for a LIDAR sensor according to an aspect of the present disclosure.

As illustrated in FIGS. 4 and 5, in an optical phased array device 100 for a LIDAR sensor, when a central wavelength and a diffraction order are determined, a length of each optical waveguide of the channel waveguide 140 may be determined. For example, a first optical waveguide WG₁ may have a length, smaller than an adjacent second optical waveguide WG₂, and may increase in length in a direction toward WG_{M} from WG₁.

The channel waveguide 140 may have a curved shape in which a straight line having a predetermined length and a curve having a predetermined curvature are combined with each other due to a length difference ΔL between adjacent optical waveguides, and may be gathered at the output end 141 based on the central wavelength.

As illustrated in FIG. 4, the output end 141 of the channel waveguide 140 may include as many optical waveguides WG₁ to WG_{M} as the number of channels, and an emission surface of the output end 141 may have a straight line shape in a direction (an X-axis direction), parallel to the ground.

As illustrated in FIG. 5, when the center wavelength is λ₀+λ₁, for example, a wavelength longer than a predetermined central wavelength, an angle at the light emission surface of the output end 141 may be changed. The output light may be changed to have a straight line shape having a positive slope with respect to a central output end as a center (0,0) on an X-Y plane. In addition, when the central wavelength is λ₀-λ₂, for example, a length shorter than the predetermined central wavelength, the angle of the exit surface of the output end 141 is changed. The output light may be changed to have a straight line having a negative slope with respect to the central output end as the center (0,0) on the X-Y plane. As described above, it can be found that the optical phased array device 100 for a LIDAR sensor steers the output light depending on a change in wavelength.

The output end 141 of the channel waveguide 140 may have a shape of being gathered on a circle concentric with having a ½ point of a Rowland circle, a focal length f of an optical waveguide, as an origin, rather than a straight line shape. In this case, the output end 141 of the channel waveguide 140 may be formed to have a predetermined curvature such that a tangent line meeting the Roland circle is perpendicular to a radius passing through a contact point thereof, rather than a form of a straight line parallel to the ground.

As illustrated in FIG. 6, the optical phased array device 100 for LIDAR sensor may not use an active control element such as an optical phase modulator according to the related art while using silicon photonics. When a laser beam having uniform light intensity is input to the input waveguide 120, the optical splitter 130 may distribute an optical signal (input laser beam) to M channels to have uniform power and may transmit the distributed signal to a waveguide corresponding to each channel of the channel waveguide 140.

In this case, the channel waveguide 140 is allowed to have diffraction characteristics such as a high-order diffraction grating by arranging optical waveguides having a constant length difference ΔL. Accordingly, an optical signal in the form of a sinc function may be output at the output end 141 of the channel waveguide 140 due to a phase difference using a length difference (or an optical path difference) of optical waveguides having different lengths for each channel.

In this case, the laser beam in the form of a sinc function, output from the output end 141 of the channel waveguide 140, may have a frequency characteristic in which side lobes are disposed on opposite sides of a main lobe. Unlike the main lobe, the side lobes transmit and receive signals in an undesired direction, so that noise may be generated during signal transmission and reception in the LIDAR sensor. In addition, the larger a size of the side lobes, the larger the crosstalk, so that sensing accuracy may be reduced. For this reason, in order to reduce interference caused by undesired information or noise, the size of the side lobe should be reduced and the crosstalk should be reduced. Accordingly, in the present disclosure, an optical phased array device for a LIDAR sensor may be manufactured using a slab waveguide to reduce the size of the side lobe and reduce the crosstalk.

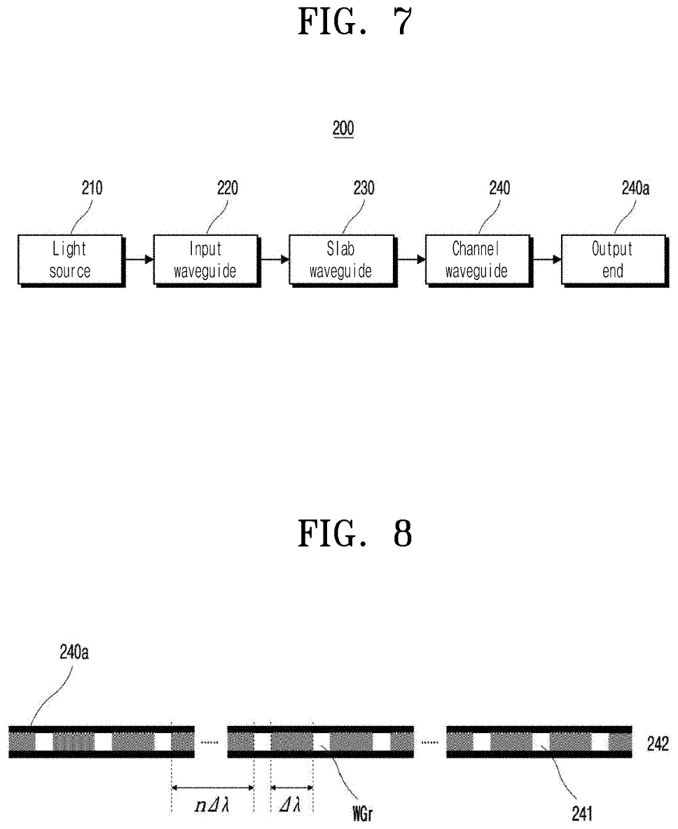

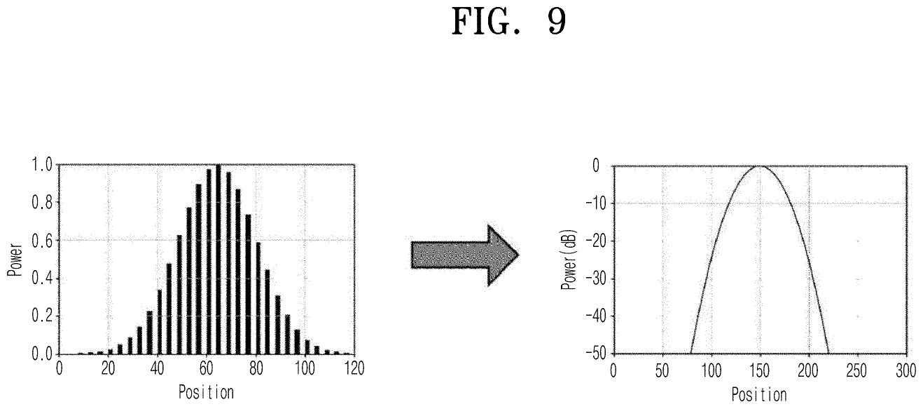

FIG. 7 is a block diagram illustrating a configuration of an optical phased array device for a LIDAR sensor according to an example embodiment of the present disclosure, FIG. 8 is a cross-sectional view illustrating an output end of a channel waveguide according to an example embodiment of the present disclosure, and FIG. 9 is a diagram illustrating a light intensity distribution at an output end of a channel waveguide of an optical phased array device for a LIDAR sensor according to an example embodiment of the present disclosure.

Referring to FIGS. 7 to 9, an optical phased array device 200 for a LIDAR sensor according to an example embodiment may include a light source 210, an input waveguide 220, a slab waveguide 230, a channel waveguide 240, and an output end 240a, but example embodiments are not limited thereto.

The light source 210 may irradiate a laser beam of a predetermined wavelength band, and may employ a wavelength tunable laser diode which may change an oscillation wavelength within a predetermined range.

The input waveguide 220 may allow the laser beam, irradiated from the light source 210, to pass therethrough. The slab waveguide 230 may be connected to a channel waveguide 240 in which a plurality of optical waveguides having a predetermined length difference ΔL are arranged. An optical signal is input from the slab waveguide 230 to the channel waveguide 240.

Accordingly, an optical signal incident from the input waveguide 220 may branch from the slab waveguide 230, and a constant phase difference may be formed in each optical signal while the branching M optical signals pass through the channel waveguide 240. Then, the branching M optical signals may interfere again at the output end 240a to be gathered as a single optical signal. In this case, an output end of the slab waveguide 230 and an input end of the channel waveguide 240 may be naturally connected to each other by a tapered or rounded optical waveguide to input the optical signal to each waveguide without optical power loss. Accordingly, the channel waveguide 240 constituting an optical waveguide array may be naturally connected to the slab waveguide 230. An optical signal, propagating through each waveguide, may be transmitted to the output end 240a of the channel waveguide 240 after undergoing only a phase change given by a length of a waveguide without optical power loss.

As illustrated in FIGS. 8 and 9, the output end 240a of the channel waveguide 240 may include a silica optical waveguide including a cladding 242 and a core 241, and may 64 or 128 core structures. As described above, it can be found that the optical phased array device 200 for a LIDAR sensor steers output light depending on a wavelength change Δλ.

As an example, a core structure of each optical waveguide may have 64 or 128 cores, each core may have a diameter of 4 m, and a distance between cores may be 2 μm. A total horizontal length (an X-axis direction) of the output end 240a of the channel waveguide 240 may be 300 m to be applied to a LIDAR sensor. When a central wavelength λ₀ of the LIDAR sensor is 1520 nm to 1575 nm, the optical phased array device 200 for the LIDAR sensor may adjust a diffraction order to detect an object having a size of 2 cm at a distance of 200 m.

Among the channel waveguides 240, a reference optical waveguide WGr may have a central wavelength λ₀ with respect to the wavelength λ of the incident light and may have maximum optical intensity. As the channel waveguide 240 moves away from the reference optical waveguide to opposite sides, the light intensity of the incident light may be decreased, so that the light intensity of the incident light may have a minimum value at an outermost optical waveguide.

Since the light intensity distribution input to the input waveguide 220 has a Gaussian shape or a sinc function shape, an output optical signal output from the channel waveguide 240 may also have a Gaussian shape or a sinc function shape. Lights, guided through the optical waveguide for each channel, may meet again and overlap each other to serve as a diffraction grating. Comparing FIGS. 6 and 9, as illustrated in FIG. 9, a component of the side lobe may be suppressed and only a signal component of the main lobe signal may be obtained, so that a side mode suppression ratio (SMSR), a ratio of peak power in a peak mode to peak power in the next mode, may be significantly increased and characteristic of crosstalk may be significantly improved. As a result, precision of the LIDAR sensor may be improved.

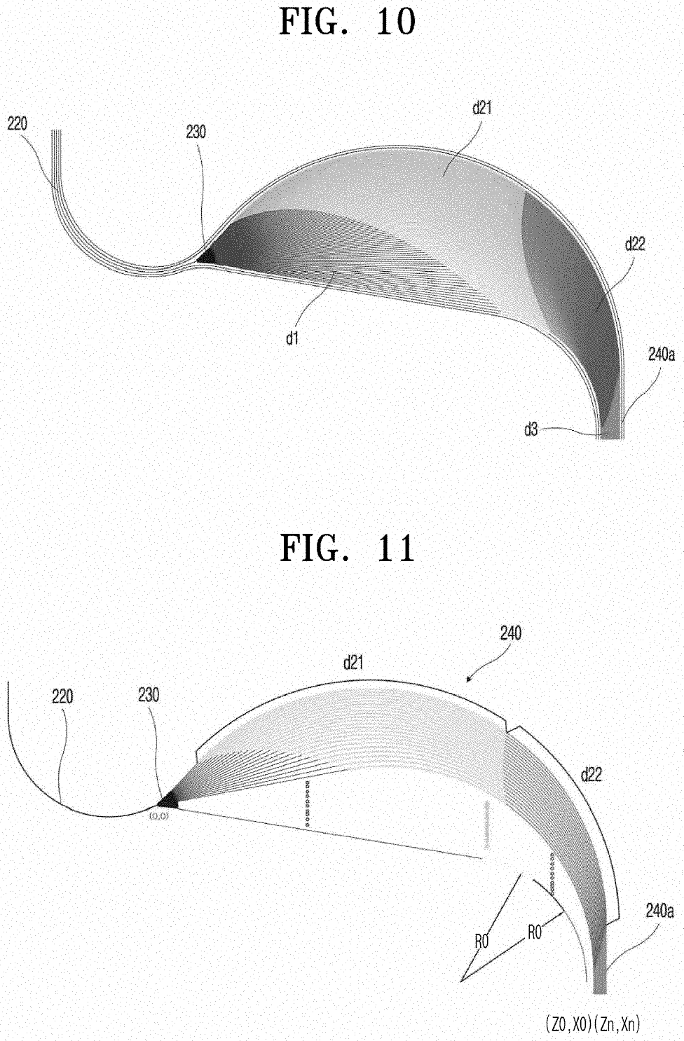

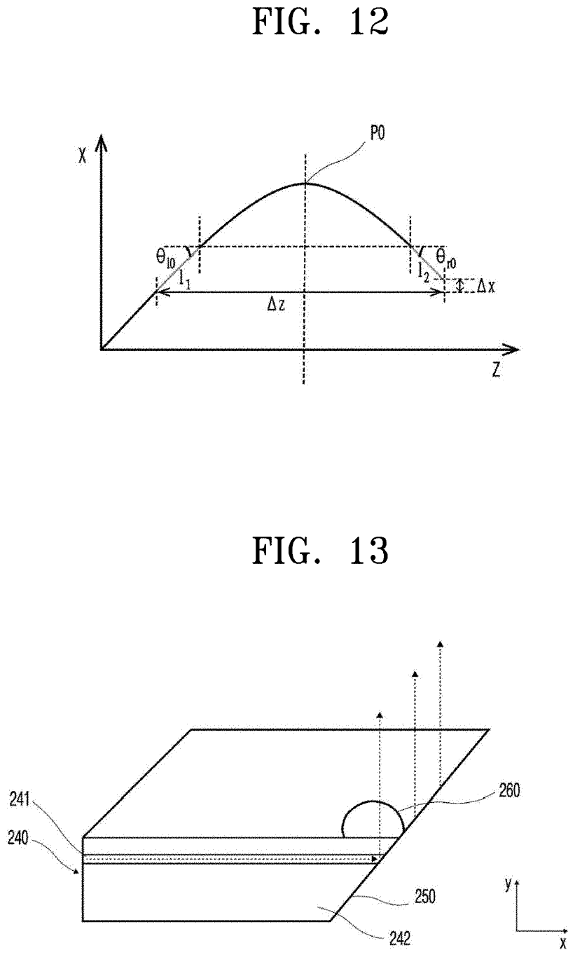

FIG. 10 is a diagram illustrating a waveguide arrangement depending on a pre-designed diffraction order and a central wavelength according to an example embodiment of the present disclosure, FIG. 11 is a diagram illustrating a difference in lengths for each waveguide region of FIG. 10, and FIG. 12 is a diagram illustrating a total length of a reference optical waveguide according to an example embodiment of the present disclosure.

As illustrated in FIGS. 10 to 12, a channel waveguide 240 may have a shape in which optical waveguides for each channel are arranged with a predetermined length difference ΔL. While incident lights travel through each optical waveguide of the optical waveguide for each channel, a constant phase difference may be formed by a length difference ΔL between the optical waveguides. In addition, while passing through an optical waveguide, the incident lights may be diffracted by m-order to be gathered in a single place, for example, the output end 240a of the channel waveguide 240.

The channel waveguide 240 may include a first waveguide region d1, a second waveguide region d2 (including d21 and d22), and a third waveguide region d3 to move an input optical signal. The first waveguide region d1 may be formed to have a straight line shape having a predetermined length. The second waveguide region d2 may be connected to the first waveguide region d1 and may be formed to have a curved shape having a predetermined curvature. The third waveguide region d3 may be formed to have a straight line shape having a predetermined length, and may allow the optical signals passing through the second waveguide region d2 to straightly travel in a predetermined direction by an optical diffraction phenomenon and to be gathered at the output end 240a. In this case, the first waveguide region d1, the second waveguide region d2, and the third waveguide region d3 may have different lengths and different curvatures depending on a length of each optical waveguide, and each optical waveguide may have a length different of ΔL from an adjacent optical waveguide.

A total length Rₜ of the reference optical waveguide may be represented as in Equation 2 below.

$${R}_{t} = {R}_{l 0} \times {θ}_{l 0} + {I}_{10} + {R}_{r 0} \times {θ}_{r 0} + {I}_{20} \qquad [ Equation 2 ]$$

In Equation 2, R₁₀ is an r value of a left arc portion with respect to a connection point P₀ of d21 and d22 in the second waveguide region, θ₁₀ is an angle of the left arc portion with respect to the connection point P₀ in the second waveguide region, l₁₀ is a length of a straight movement in the first waveguide region, Rᵣ₀ is an r value of a right arc portion with respect to the connection point P₀ in the second waveguide region, Oro is an angle of the right arc portion with respect to the connection point P₀ in the second waveguide region, and l₂₀ is a length of a straight movement of the third waveguide region.

The second waveguide region d2 of the channel waveguide may be formed to have a curved shape having a predetermined curvature, for example, an arc having a predetermined length. However, each optical waveguide in the second waveguide region d2 is has a length difference ΔL from a neighboring waveguide, and thus may have an asymmetrically curved shape with respect to a point forming inflection of each optical waveguide (a connection point). Accordingly, when the total length of the reference optical waveguide is calculated, the length of the second waveguide region should be calculated by calculating and summing the lengths of the left arc portion d21 and the right arc portion d22 with respect to the connection point.

Equation 3, Equation 4, and Equation 5 may be obtained using Equation 2 and an optical path difference

$$\pm Δ L = \frac{m}{{n}_{c}} λ ,$$

a focal length L_{f}, a Z-axis focal length L_{fz}, an X-axis focal length L_{fx}, a width between waveguides in a final position (D_{z}, Dₓ), a Z-axis final positon of a reference point z₀, an X-axis final position of the reference point x₀, a Z-axis final position of an n-th waveguide z₀±n×D_{z}, an X-axis final position of the n-th waveguide x₀±n×Dₓ, a width after traveling by a focal length d, an intermediate angle after traveling by the focal length

$${tan}^{- 1} \frac{d}{{L}_{f}} ,$$

an initial traveling angle θ₀, and an n-th traveling angle

$${θ}_{n} + {θ}_{0} + n \times {tan}^{- 1} \frac{d}{{L}_{f}} .$$

$$( {R}_{10} * {θ}_{10} + {I}_{10} + {R}_{r 0} * {θ}_{r 0} + {I}_{20} ) \pm Δ L * n = {I}_{1 n} + {I}_{2 n} + {R}_{n} ( {θ}_{n} + {θ}_{0} ) \qquad [ Equation 3 ]$$

$${z}_{0} \pm n * {D}_{z} = {I}_{1 n} cos ( {θ}_{n} ) + {R}_{n} ( sin ( {θ}_{n} ) + sin {θ}_{0} ) + {I}_{2 n} cos ( {θ}_{0} ) + {L}_{fz} \qquad [ Equation 4 ]$$

$${x}_{0} \pm n * {D}_{z} = {I}_{1 n} cos ( {θ}_{n} ) + {R}_{n} ( sin ( {θ}_{n} ) + sin {θ}_{0} ) + {I}_{2 n} cos ( {θ}_{0} ) + {L}_{fz} \qquad [ Equation 5 ]$$

$$Equation 6 and Equation 7 are obtained by modifying Equation 3 into an equation for {I}_{1 n} and substituting the modified equation into Equation 4 and Equation 5. \qquad [ Equation 6 ]$$

$${I}_{2 n} ( cos ( {θ}_{0} ) - cos ( {θ}_{n} ) ) + {R}_{n} ( sin ( {θ}_{n} ) + sin ( {θ}_{0} ) - ( {θ}_{n} + {θ}_{0} ) cos ( {θ}_{n} ) = {z}_{0} \pm n * {D}_{z} - {L}_{fz} - ( ( {R}_{10} * {θ}_{10} + {I}_{10} + {R}_{r 0} * {θ}_{r 0} + {I}_{20} ) \pm Δ L * n ) cos ( {θ}_{n} ) \qquad [ Equation 7 ]$$

$$- {I}_{2 n} ( sin ( {θ}_{0} ) + sin ( {θ}_{n} ) ) + {R}_{n} ( cos ( {θ}_{0} ) - cos ( {θ}_{n} ) - ( {θ}_{n} + {θ}_{0} ) sin ( {θ}_{n} ) = {x}_{0} \pm n * {D}_{x} - {L}_{fx} - ( ( {R}_{10} * {θ}_{10} + {I}_{10} + {R}_{r 0} * {θ}_{20} ) \pm Δ L * n ) sin ( {θ}_{n} )$$

Finally, Equation 8, Equation 9, and Equation 10 are obtained by modifying Equation 6 into an equation for Rₙ and substituting the modified equation into Equation 7.

$$\begin{matrix}{L}_{in} = \frac{( \frac{\begin{matrix}( {z}_{0} \pm n + {D}_{z} - {L}_{n} - ( ( {R}_{10} + {θ}_{10} + {l}_{10} + {R}_{τ n} + {σ}_{τ0} + {l}_{20} ) \pm Δ L + n ) cos ( {θ}_{b} ) ) \\ cos ( {θ}_{b} ) - cos ( {θ}_{n} ) - ( {θ}_{n} + {θ}_{0} ) sin ( {θ}_{n} ) )\end{matrix}}{sin ( {θ}_{n} ) + sin ( {θ}_{0} ) - ( {θ}_{n} + {θ}_{{0}_{0}} ) cos ( {θ}_{n} )} - \begin{matrix}( {x}_{0} \pm n + {D}_{x} - {L}_{fx} - ( {R}_{10} + {θ}_{10} + {l}_{10} + \\ {R}_{τ0} + {θ}_{τ0} + {l}_{20} ) \pm Δ L + n ) sin ( {θ}_{n} )\end{matrix} )}{sin ( {θ}_{n} ) + sin ( {θ}_{0} ) - \frac{( cos ( {θ}_{0} ) - cos ( {θ}_{n} ) ) ( cos ( {θ}_{n} ) - cos ( {θ}_{n} ) - ( {θ}_{n} + {θ}_{0} ) sin ( {θ}_{n} ) )}{sin ( {θ}_{n} ) + sin ( {θ}_{n} ) - ( {θ}_{n} + {θ}_{0} ) cos ( {θ}_{0} )}} & [ Equation 8 ] \\ {R}_{n} = \frac{{z}_{0} \pm n * {D}_{z} - {L}_{fz} - ( ( {R}_{10} * {θ}_{10} + {l}_{10} + {R}_{r 0} * {θ}_{r 0} + {l}_{20} ) \pm Δ L * n ) cos ( {θ}_{n} ) - {l}_{2 n} ( cos ( {θ}_{0} ) - cos ( {θ}_{n} ) )}{sin ( {θ}_{n} ) + sin ( {θ}_{0} ) - ( {θ}_{u} + {θ}_{0} ) cos ( {θ}_{n} )} & [ Equation 9 ] \\ {l}_{1 n} = ( {R}_{10} * {θ}_{10} + {l}_{10} + {R}_{10} * {θ}_{r 0} + {l}_{20} ) \pm Δ L * n - {l}_{2 n} - {R}_{n} ( {θ}_{n} + {θ}_{0} ) & [ Equation 10 ]\end{matrix}$$

A total length of each waveguide may be obtained using the calculated Equation 8, Equation 9, and Equation 10.

FIG. 13 is a cross-sectional view illustrating a configuration of a channel waveguide according to an example embodiment of the present disclosure.

As illustrated in FIG. 13, the channel waveguide 240 may include a silica optical waveguide. The silica optical waveguide, including a cladding 242 and a core 241, may be manufactured through the following processes to form a low-loss optical waveguide thin film. A plasma-enhanced chemical vapor deposition (PECVD) process/high-temperature heat treatment process of depositing SiO₂ or Ge—SiO₂ and SiON thick film on a silicon (Si) wafer by mixing SiH₄, N₂O, and N₂ gases, a photolithography process using I-line stepper, an etching process, and a deposition process of depositing a capping layer having no contraction to a waveguide to which a heat treatment process with minimized polarization dependence is applied.

In the silica optical waveguide thin film forming process, a silica thin film refractive index difference may be 2.0 to 2.5% and refractive index uniformity may be within ±0.0005. In the photolithography process using the I-line stepper, a thin film pattern and an OPA pattern may be formed. In the etching process using inductively coupled plasma (CCP) equipment and capacitively coupled plasma (CCP) equipment, verticality of 90°+3° and improved uniformity within 8 inches may be obtained through hardmask etching, silica thin film etching, and OPA vertical etching.

The channel waveguide 240, in which such silica optical waveguides are arranged for each channel, may have a horizontal steering range of 15 degrees or more, an optical branch number of 64 channels or more, a horizontal launch angle of 1 degree or less, a free spectral range (FSR) of 10 nm or less, insertion loss of 2 dB or less, and the side-lobe suppression of 13 dB or more.

The core 241 may move incident light along a predetermined path. Since the core 241 has an optical path difference, different from that of a core of an adjacent optical waveguide, a phase difference may occur in light passing through each path. The cladding 242 may have a refractive index, lower than a refractive index of the core 241 and may be disposed around the core 241.

Output ends of the channel waveguides 140 and 240, in which M optical waveguides including the core 241 and the cladding 242 are arranged, may have an inclined surface 250 having a predetermined angle of inclination (for example, 45°) with respect to the core 241, and the inclined surface 250 may totally reflect light to an upper surface (in a vertically upward direction of a waveguide) at a predetermined angle or more with respect to the inclined surface 250. Accordingly, the output end 240a of the channel waveguide 240 may totally reflect and output incident light when a traveling direction of the light traveling along the core 241 is greater than or equal to a critical angle with respect to the inclined surface 250 in a predetermined direction on a free space by the inclined surface 250.

In this case, the optical phased array device 200 for a LIDAR sensor may further include a lens 260 for improving light condensing efficiency of light reflected by the inclined surface 250 and output in a predetermined direction. In this case, the lens 260 may be formed on a surface of the cladding 242 and may intersect the surface of the cladding 242 while an optical axis of the core 241 and an optical axis of the lens 260 is maintained at an angle of 90 degrees.

As described above, according to one aspect of the present embodiment, an optical phased array (OPA) using a silica optical waveguide having low insertion loss and excellent diffraction characteristics may be integrated into a device to be provided to have a packageable size.

In addition, according to one aspect of the present embodiment, an active device such as a phased shifter array for adjusting an optical path difference is not required and a phase may be manually adjusted. Thus, manufacturing costs may be reduced, and an OPA device component may be used alone and may be applied to a LIDAR sensor to steer beam.

Although the present disclosure and its advantages have been described in detail, it should be understood that various changes, substitutions and alterations can be made herein without departing from the spirit and scope of the disclosure as defined by the following claims.

### CROSS-REFERENCE TO RELATED APPLICATION

This application claims the priority under 35 U.S.C § 119(a) of Patent Application No. 10-2021-0110921, filed on Aug. 23, 2021 in Korea, the entire contents of which are incorporated herein by reference. In addition, this non-provisional application claims the priority in countries, other than the U.S., with the same reason based on the Korean Patent Application, the entire contents of which are hereby incorporated by reference.

What is claimed is:

1. An optical phased array device for a LIDAR sensor, the optical phased array device comprising:
a light source configured to irradiate a laser beam having a predetermined wavelength band;
an input waveguide through which the laser beam irradiated from the light source passes;
a slab waveguide disposed at an output end of the input waveguide to branch an optical signal input from the input waveguide; and
a channel waveguide configured to distribute and guide the optical signal, branched by the slab waveguide, to M channels and to radiate the optical signal onto a free space,
wherein
the channel waveguide comprises a silica optical waveguide disposed for each of the M channels, and a length of each of the optical waveguides has a length difference ΔL from an adjacent waveguide.

2. The optical phased array device as set forth in claim 1, wherein
the light source employs a wavelength tunable laser diode for changing an oscillation wavelength within a predetermined range.

3. The optical phased array device as set forth in claim 1, wherein
when a diffraction order m (where m is an integer) is determined based on a central wavelength λ₀ of light incident from a center of an input end of the channel waveguide and traveling to a center of an output end of the channel waveguide, the length difference ΔL is determined depending on the central wavelength λ₀ and the diffraction order m.

4. The optical phased array device as set forth in claim 3, wherein
a traveling direction of incident light is changed by a length difference of each optical waveguide of the channel waveguide when a wavelength of the incident light is changed.

5. The optical phased array device as set forth in claim 1, wherein
each of the waveguides arranged in the channel waveguide comprises:
a first waveguide region formed to have a straight line shape having a predetermined length to propagate an optical signal input from the input waveguide;
a second waveguide region connected to the first waveguide region and formed to have a curved shape having a predetermined curvature; and
a third waveguide region formed to have a straight line shape having a predetermined length such that an optical signal passing through the second waveguide region travels in a predetermined direction by optical diffraction, and
the first waveguide region, the second waveguide region, and the third waveguide region allow each waveguide to have a length difference ΔL from an adjacent waveguide.

6. The optical phased array device as set forth in claim 1, wherein
an inclined surface having a predetermined slope is formed at an output end of the channel waveguide.

7. The optical phased array device as set forth in claim 1, wherein
a waveguide disposed in the channel waveguide comprises a core and a cladding, and
a lens is disposed on a surface of the cladding, and an optical axis of the core and an optical axis of the lens intersect each other at a single point.
